(19) United States
(12) Patent Application Publication
(10) Pub. No.: US 2026/0222528 A1
(43) Pub. Date: Jul. 30, 2026

(54) 3D IMAGE DISPLAY METHOD AND APPARATUS, MEDIUM AND DEVICE

(71) Applicant: Huizhou TCL Cloud Internet Corporation Technology Co.Ltd., Huizhou, Guangdong (CN)

(72) Inventors: Lu ZENG, Huizhou, Guangdong (CN); Yang YU, Huizhou, Guangdong (CN); Ke LIN, Huizhou, Guangdong (CN); Pei JIANG, Huizhou, Guangdong (CN)

(73) Assignee: Huizhou TCL Cloud Internet Corporation Technology Co.Ltd., Huizhou, Guangdong (CN)

(21) Appl. No.: 19/144,491

(22) PCT Filed: Oct. 13, 2023
(86) PCT No.: PCT/CN2023/124516

§ 371 Date: Jun. 29, 2025

(30) Foreign Application Priority Data
Dec. 30, 2022 (CN) 202211734955.0

(51) Int. Cl. H04N 13/139; H04N 13/172; H04N 13/302; H04N 13/398

(52) U.S. Cl. CPC H04N 13/139; H04N 13/172; H04N 13/302; H04N 13/398

(57) ABSTRACT

Provided in the embodiment of the present application are a 3D image display method and apparatus, a medium and a device. The method comprises: receiving a 3D image display request; acquiring an initial left image frame and an initial right image frame; splicing the initial left image frame and the initial right image frame to obtain an image to be displayed; and performing a data reading and cutting operation on the image to obtain a left picture frame and a right picture frame, and then displaying a picture. The present application may avoid incomplete left and right frames in the case of display output delay of main board ends.

This application claims priority to Chinese Patent Applications No. 2022117349550, filed on Dec. 30, 2022 and entitled “3D IMAGE DISPLAY METHOD AND APPARATUS, MEDIUM AND DEVICE”. The entire disclosures of the above application are incorporated herein by reference.

### TECHNICAL FIELD

The present application relates to the field of electronic communication technologies, and more particularly to the field of 3D image display technologies, and specifically to a 3D image display method and apparatus, medium and device.

### BACKGROUND TECHNOLOGY

3D display products based on flat panel display technology, whether using active or passive glasses, operate on the principle of displaying alternating frame sequences of left-eye and right-eye images on a screen. A light shutter is added between viewer's eyes and the screen to rotate a polarization angle of light emitted from a display. The polarized light, after being rotated by the light shutter, works in conjunction with orthogonal polarizers placed over user's left and right eyes, enabling selective light transmission to either the left eye or the right eye. This setup ensures that the left-eye image displayed on the screen is invisible to the right eye, and the right-eye image is invisible to the left eye, thereby creating different viewing angles for each eye at the user end to achieve a 3D display effect.

A key requirement for achieving this type of 3D display is the formation of a stable frame sequence with alternating left-eye and right-eye images. In non-real-time operating systems such as Android, the operating efficiency is affected by software scheduling and system load, leading to instability in frame output. Taking a 120Hz MIPI data output as an example, a display serial interface (DSI) processor is equipped with two buffers (storage regions). When buffer1 is outputting data (sending to MIPI display), buffer2 can be used for data writing; when buffer2 is in output mode, buffer1 is used for display. The buffer writing operation is controlled by the Vsync signal, with one frame written each time a Vsync signal arrives. Theoretically, a Vsync signal arrives every 8.33 ms. The DSI hardware outputs data strictly at 120 Hz based on the hardware clock. However, the Vsync signal itself is subject to instability. When a Vsync timeout occurs due to this instability, it may result in no data being written to buffer1 or buffer2, or incomplete data being written. Since the DSI hardware clock requires outputting at exactly 120 Hz, in such cases, the DSI will directly repeat the data from the previous frame. For example, when buffer1 is outputting data, a Vsync signal should arrive to trigger the writing of the next frame into buffer2. If the Vsync signal is delayed or times out, the next frame may not be written into buffer2 in time. As a result, the DSI continues to output the data from buffer1 through MIPI, leading to a repeated frame. This prevents the formation of a stable sequence of alternating left-eye and right-eye frames, making it impossible for the user to perceive different images with each eye, and thus failing to produce the intended 3D display effect.

### SUMMARY OF INVENTION

Embodiments of the present application provide a 3D image display method and apparatus, medium and device. By using the 3D image display method provided in the embodiments of this application, left and right image frames are spliced into a single large image frame, with the left and right image frames arranged vertically. Additionally, a first start identifier for instructing an application end to perform an image start scanning operation and a first end identifier for instructing the application end to perform an image end scanning operation are inserted at both the beginning and end of the left and right image frames. This allows the application end to receive the left image frame located in an upper half of the large image frame and then immediately receive a right image frame located in a lower half of the large image frame. As a result, a complete left and right frame image can be displayed at a display end. Compared with the traditional method of transmitting left and right image frames separately, this approach can avoid the issue of incomplete left or right frames caused by display transmission delays from a main board, thereby ensuring that left and right images can be displayed simultaneously.

An embodiment of the present application provides a 3D image display method, comprising:
receiving a 3D image display request sent from an application end.
acquiring, according to the 3D image display request, a screen output resolution format of the application end, and continuous initial left frame images and initial right frame images.
splicing the initial left frame images and the initial right frame images according to the screen output resolution format to obtain an image to be displayed.
sending the image to be displayed to the application end for data reading and cutting operation, to obtain a left frame image and a right frame image.
sending the left frame image and the right frame image to a display end for image display.

In the 3D image display method described in the embodiments of the present application, after splicing the initial left frame images and the initial right frame images to obtain the image to be displayed, the method further comprises:
respectively inserting, at head and tail ends of the initial left frame images and the initial right frame images within the image to be displayed, a first start identifier for instructing the application end to perform an image start scanning operation, and a first end identifier for instructing the application end to perform an image end scanning operation.

In the 3D image display method described in the embodiments of the present application, when the screen output resolution format is a first format, the splicing of the initial left frame images and the initial right frame images to obtain the image to be displayed comprises:
respectively performing an image format conversion operation on the initial left frame images and the initial right frame images, so that a row data of the initial left frame images and the initial right frame images is extended and a column data of the initial left frame images and the initial right frame images is reduced.
performing a vertical splicing on the initial left frame images and the initial right frame images after the image format conversion operation to obtain the image to be displayed.

In the 3D image display method described in the embodiments of the present application, when the screen output resolution format is a second format, the splicing of the initial left frame images and the initial right frame images to obtain the image to be displayed comprises:
performing a vertical splicing on the initial left frame images and the initial right frame images to obtain the image to be displayed.

In the 3D image display method described in the embodiments of the present application, after splicing the initial left frame images and the initial right frame images to obtain the image to be displayed, the method further comprises:
respectively inserting, at head and tail ends of each row of data in the initial left frame images and the initial right frame images, a second start identifier for instructing the application end to perform a row data start scanning operation, and a second end identifier for instructing the application end to perform a row data end scanning operation.

Accordingly, another aspect of the embodiments of the present application further provides a 3D image display method, comprising:
receiving an image to be displayed sent from a main board end.
performing a data reading and cutting operation on the image to be displayed to obtain a left frame image and a right frame image.
sending the left frame image and the right frame image to a display end for image display.

In the 3D image display method described in the embodiments of the present application, performing a data reading and cutting operation on the image to be displayed to obtain a left frame image and a right frame image comprises:
when a first start identifier is detected in the image to be displayed, performing an image start scanning operation on the image to be displayed.
treating data between a second start identifier and a second end identifier in the image to be displayed as one row of data for data reading and cutting operation, and continuing the data reading and cutting operation until a first end identifier is detected in the image to be displayed, at which point performing an image end scanning operation to obtain the left frame image.
when another first start identifier is detected in the image to be displayed, continuing the image start scanning operation.
treating the data between the second start identifier and the second end identifier in the image to be displayed as one row of data for data reading and cutting operation, and continuing the data for data reading and cutting operation until a first end identifier is detected in the image to be displayed, at which point performing an image end scanning operation to obtain the right frame image.

Accordingly, another aspect of the embodiments of the present application further provides a 3D image display apparatus, comprising:
a request receiver configured to receive a 3D image display request sent from an application end.
a data acquisitor configured to acquire, according to the 3D image display request, a screen output resolution format of the application end, and continuous initial left frame images and initial right frame images.
an image splicer configured to splice the initial left frame images and the initial right frame images according to the screen output resolution format to obtain an image to be displayed.
a frame cutter configured to send the image to be displayed to the application end for data reading and cutting operation, to obtain a left frame image and a right frame image.
a frame display sender configured to send the left frame image and the right frame image to a display end for image display.

Accordingly, another aspect of the embodiments of the present application further provides a storage medium, wherein the storage medium stores a plurality of instructions, and the instructions is adapted to be loaded by a processor to execute the 3D image display method as described above.

Accordingly, another aspect of the embodiments of the present application further provides a terminal device, comprising a processor and a memory, wherein the memory stores a plurality of instructions, and the processor loads the instructions to execute the 3D image display method as described above.

The embodiments of the present application provide a 3D image display method and apparatus, medium and device. The method includes: receiving a 3D image display request sent from an application end; acquiring, according to the 3D image display request, a screen output resolution format of the application end, and continuous initial left frame images and initial right frame images; splicing the initial left frame images and the initial right frame images according to the screen output resolution format to obtain an image to be displayed; sending the image to be displayed to the application end for data reading and cutting operation to obtain a left frame image and a right frame image; and sending the left frame image and the right frame image to a display end for image display. By using the 3D image display method provided in the embodiments of the present application, the left and right image frames are spliced into a single large image frame, with the left and right image frames arranged vertically. Additionally, both the beginning and end of the left and right image frames are respectively inserted with a first start identifier for instructing the application end to perform an image start scanning operation, and a first end identifier for instructing the application end to perform an image end scanning operation. This allows the application end to receive the left image frame located in the upper half of the large image frame and then immediately receive the right image frame located in the lower half of the large image frame. Eventually, the complete left and right frame images are displayed on the display end. Compared with the traditional method of transmitting left and right image frames separately, this approach can avoid the issue of incomplete left or right frames caused by display transmission delays from the main board, thereby ensuring that the left and right images can be displayed simultaneously.

### BRIEF DESCRIPTION OF THE DRAWINGS

In order to more clearly illustrate technical solutions in embodiments of the present application, accompanying drawings required for describing the embodiments are briefly introduced below. Apparently, the drawings described below are only some embodiments of the present application. For those skilled in the art, other drawings can be obtained based on these drawings without creative efforts.

FIG. 1 is a flow diagram illustrating a 3D image display method provided in embodiments of the present application.

FIG. 2 is a schematic structural diagram of a 3D image display apparatus provided in embodiments of the present application.

FIG. 3 is another schematic structural diagram of a 3D image display apparatus provided in embodiments of the present application.

FIG. 4 is yet another schematic structural diagram of a 3D image display apparatus provided in embodiments of the present application.

FIG. 5 is a schematic structural diagram of a terminal device provided in embodiments of the present application.

### DETAILED DESCRIPTION OF THE EMBODIMENTS

The technical solutions in the embodiments of the present application will now be clearly and fully described with reference to the accompanying drawings. It is evident that the described embodiments are only part of the embodiments of the present application, and not all embodiments. All other embodiments obtained by those skilled in the art based on the embodiments of the present application without creative efforts shall fall within the scope of protection of the present application.

It should be noted that the following content is a brief introduction to the background of this solution:

This solution primarily addresses the technical problem that, due to the current image transmission method in which the left and right image frames are transmitted separately, display transmission delays from the main board may result in the application end receiving incomplete left and right frame images, thus failing to simultaneously display a left and a right image. It is understood that 3D display products based on flat panel display technology—whether using active or passive glasses—operate on the principle of displaying alternating frame sequences of left-eye and right-eye images on the screen. A light shutter is placed between the human eyes and the screen to rotate the polarization angle of the light emitted from the display. The polarized light, after being rotated by the light shutter, cooperates with the orthogonally oriented polarizers placed over the user's left and right eyes, enabling selective transmission of light to either the left or right eye. This allows the left-eye image on the screen to be invisible to the right eye, and the right-eye image to be invisible to the left eye, thereby generating different perspectives for each eye and achieving a 3D display effect on the user side.

A key requirement for achieving this type of 3D display is the formation of a stable frame sequence with alternating left and right images. In non-real-time operating systems such as Android, the operational efficiency is affected by software scheduling and system load, which may lead to instability in frame output. Taking a 120 Hz MIPI data output as an example, the DSI (processor) is equipped with two buffers (memory regions). When buffer1 is outputting data (to MIPI display), buffer2 can be used for writing data; when buffer2 is in output mode, buffer1 is used for display. The writing action to the buffer is controlled by the Vsync signal, with one frame written each time a Vsync signal arrives. Theoretically, a Vsync signal should arrive every 8.33 milliseconds. The DSI hardware outputs data strictly at 120 Hz according to the hardware clock. However, the Vsync signal itself is unstable. When the Vsync signal experiences a timeout due to this instability, it can lead to no data being written to buffer1 or buffer2, or the data being only partially written. Since the DSI hardware clock must output data at exactly 120 Hz, the DSI will, in such cases, repeat the data from the previous frame. For example, when buffer1 is outputting data, a Vsync signal is expected to arrive and trigger the writing of the next frame into buffer2. However, if the Vsync signal times out and the writing of the next frame into buffer2 is not completed in time, the DSI will continue to output the display data from buffer1 via MIPI, resulting in a repeated frame. This prevents the formation of a stable alternating frame sequence of left and right images, making it impossible for the user to perceive different images with each eye, and thus failing to achieve a proper 3D visual effect.

In summary, a simpler and more effective method is needed to address the problem where the DSI fails to output a stable alternating sequence of left and right frames due to the instability of the Vsync signal.

To solve the above technical problem, an embodiment of the present application provides a 3D image display method. By using the 3D image display method provided in this embodiment, the left and right image frames are spliced into a single large image frame, with the left and right image frames arranged vertically. Furthermore, both the beginning and end of the left and right image frames are inserted with a first start identifier, which instructs the application end to initiate image scanning, and a first end identifier, which instructs the application end to end image scanning. This allows the application end to receive the left image frame located in the upper half of the large image frame, and then immediately receive the right image frame located in the lower half. As a result, the display end can present a complete view of both the left and right frames. Compared to the traditional method of separately transmitting left and right image frames, this approach effectively prevents incomplete left or right frames from appearing due to display transmission delays at the main board end, thereby ensuring that one left and one right image can be displayed simultaneously.

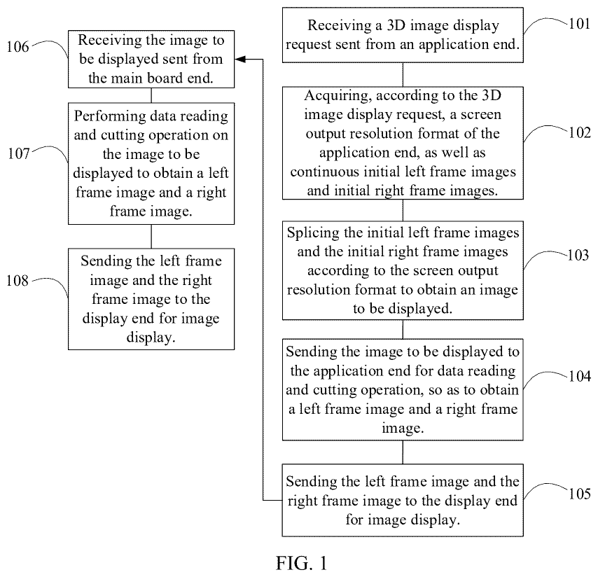

Refer to FIG. 1, which is a flow diagram illustrating a 3D image display method provided in embodiments of the present application. The 3D image display method is applied in a terminal device. In this solution, the terminal device is divided into a main board end and an application end, and interaction between the main board end and the application end is achieved through a wireless or wired communication network. Optionally, the terminal device may be a terminal or a server. Optionally, the server may be a standalone physical server, a server cluster composed of multiple physical servers, or a distributed system. It may also be a cloud server providing basic cloud computing services such as cloud services, cloud databases, cloud computing, cloud functions, cloud storage, network services, cloud communication, middleware services, domain name services, security services, content delivery network (CDN), as well as big data and artificial intelligence platforms. Optionally, the terminal may be a smartphone, tablet, laptop, desktop computer, smart speaker, smartwatch, intelligent voice interaction device, smart home appliance, or in-vehicle terminal, among others, but is not limited thereto.

In one embodiment, the method may include the following steps:
Step 101: Receiving a 3D image display request sent from an application end.

It should be noted that the 3D image display method provided in this solution is mainly applicable to scenarios where 3D image data is transmitted between an application end-such as AR glasses or other viewing devices-and a main board end such as a mobile phone or computer. When a user wishes to use the 3D display function, the 3D image display request can be sent from the application end (for example, AR glasses) to the main board end via a touch screen or button on the application end.
Step 102: Acquiring, according to the 3D image display request, a screen output resolution format of the application end, as well as continuous initial left frame images and initial right frame images.

In this embodiment, a main board end may adjust the processing method for the initial left frame images and initial right frame images based on the current screen output resolution format of the application end, so that the images sent to the application end for display can meet the hardware requirements of the application end.
Step 103: Splicing the initial left frame images and the initial right frame images according to the screen output resolution format to obtain an image to be displayed.

The main board end determines the screen output resolution format according to the 3D image display request sent from the application end, and splices the initial left frame image and the initial right frame image to obtain an image to be displayed.

When the screen output resolution format is the first format, 3840x1080, image format conversion operations are respectively performed on the initial left frame image and the initial right frame image, so that the row data of the initial left frame image and the initial right frame image is extended and the column data is reduced. The initial left and right frame images after the image format conversion are then vertically spliced to obtain the image to be displayed. By way of example, the initial left and right frame images are converted from their original resolution of 1920×1080 to 3840×540. Then, the 3840×540 left frame image and the 3840×540 right frame image are combined in a top-and-bottom arrangement to form a 3840×1080 image to be displayed.

When the screen output resolution format is the second format, 1920×2160, the initial left frame image and the initial right frame image are vertically spliced to obtain the image to be displayed. By way of example, the initial left frame image and the initial right frame image, each with a resolution of 1920×1080, are combined in a top-and-bottom arrangement to form a 1920×2160 image to be displayed.
Step 104: Sending the image to be displayed to the application end for data reading and cutting operation, so as to obtain a left frame image and a right frame image.

In this step, the main board end sends the image to be displayed to the application end for data reading and cutting operation, enabling the application end to separate and extract the left frame image and the right frame image from the image to be displayed. This also ensures that the application end can receive continuous left and right frame images.

It should be noted that, under normal circumstances, the traditional method of separately transmitting left and right image frames involves automatically appending a start identifier and an end identifier to the beginning and end of each frame after it is processed by the main board end. These identifiers are used to instruct the application end to perform image start and end scanning operations. However, in the present solution, the left and right frame images are spliced into a single large image for display transmission. In order for the application end to automatically identify and separate the left and right frame images from the image to be displayed, the method further includes the following step after splicing the initial left frame image and the initial right frame image to obtain the image to be displayed:

Respectively inserting, at head and tail ends of the initial left frame images and the initial right frame images within the image to be displayed, a first start identifier for instructing the application end to perform an image start scanning operation, and a first end identifier for instructing the application end to perform an image end scanning operation.

In this solution, the first start identifier is implemented using VBP, where VBP data corresponds to the row data of a controllable area located above the active display area. The first end identifier is implemented using VFP, where VFP data corresponds to the row data of a controllable area located below the active display area. When the application end finishes receiving the left frame image located at the upper part of the image to be displayed, it considers the first frame image, i.e., the left frame image, as completely received because it contains a complete VBP and VFP. Similarly, the right frame image located at the lower part of the image to be displayed is also regarded as a complete frame image, i.e., the right frame image. This allows the application end to seamlessly receive the right frame image in the lower half of the image immediately after receiving the left frame image in the upper half. As a result, the display end can present a complete and synchronized display of both left and right frame images. Compared with the traditional method of transmitting left and right image frames separately, this approach effectively prevents the issue of incomplete frames caused by display transmission delays from the main board end, thereby ensuring simultaneous left-and-right image display.

In some embodiments, after splicing the initial left frame images and the initial right frame images to obtain the image to be displayed, the method further includes the following steps:

Respectively inserting, at the head and tail ends of each row of data in the initial left frame images and the initial right frame images, a second start identifier for instructing the application end to perform a row data start scanning operation, and a second end identifier for instructing the application end to perform a row data end scanning operation. The second start identifier is implemented using HBP (Horizontal Back Porch), and the second end identifier is implemented using HFP (Horizontal Front Porch). Since HBP and HFP are inserted at both the beginning and end of each row of data, the application end recognizes the row as a complete set of row data, and then packages the row data and sends it to the display end for display.
Step 105: Sending the left frame image and the right frame image to the display end for image display.

In another embodiment, the method further comprises the following steps:
Step 106: Receiving the image to be displayed sent from the main board end.
Step 107: Performing data reading and cutting operation on the image to be displayed to obtain a left frame image and a right frame image.

When the application end detects the first start identifier in the image to be displayed, it performs an image start scanning operation on the image to be displayed; the data between the second start identifier and the second end identifier in the image to be displayed is treated as one row of data for data reading and cutting operation. This continues until the first end identifier is detected in the image to be displayed, at which point an image end scanning operation is performed to obtain the left frame image.

When the application end detects another first start identifier in the image to be displayed, it continues to perform the image start scanning operation on the image to be displayed; the data between the second start identifier and the second end identifier in the image to be displayed is treated as one row of data for data reading and cutting operation. This continues until the first end identifier is detected in the image to be displayed, at which point an image end scanning operation is performed to obtain the right frame image.
Step 108: Sending the left frame image and the right frame image to the display end for image display.

All of the above optional technical solutions may be combined in any manner to form optional embodiments of the present application, and such combinations will not be repeated herein.

In specific implementations, the present application is not limited by the execution order of the described steps. Provided there is no conflict, certain steps may be executed in a different order or performed simultaneously.

As described above, the 3D image display method provided in the embodiments of the present application includes: receiving a 3D image display request sent from the application end; acquiring, according to the 3D image display request, the screen output resolution format of the application end, along with continuous initial left frame images and initial right frame images; splicing the initial left frame image and the initial right frame image according to the screen output resolution format to obtain an image to be displayed; sending the image to be displayed to the application end for data reading and cutting operation to obtain a left frame image and a right frame image; and sending the left frame image and the right frame image to the display end for image display. By utilizing the 3D image display method provided in this embodiment of the present application, the left and right image frames are spliced into a single large image frame, with the left and right frames arranged vertically. In addition, both the beginning and end of the left and right image frames are inserted with a first start identifier to instruct the application end to begin image scanning, and a first end identifier to instruct the application end to end image scanning. This allows the application end to receive the left image frame located in the upper half of the large image frame and then immediately receive the right image frame located in the lower half. Ultimately, the display end presents a complete view of both the left and right frame images. Compared to the traditional method of separately transmitting left and right image frames, this approach effectively avoids the issue of incomplete left or right frames caused by display transmission delays from the main board end, thereby ensuring simultaneous left-and-right image display.

The embodiments of the present application also provide a 3D image display apparatus, which can be integrated into a terminal device.

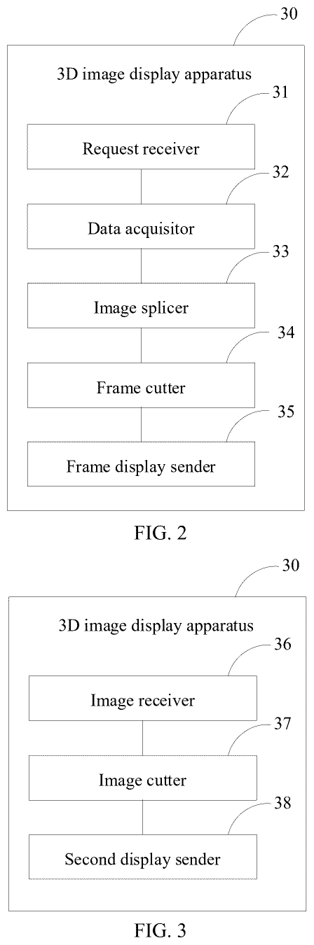

Refer to FIG. 2, which is a schematic structural diagram of a 3D image display apparatus provided in the embodiments of the present application. The 3D image display apparatus 30 may include:
a request receiver 31 configured to receive a 3D image display request sent from the application end.
a data acquisitor 32 configured to acquire, according to the 3D image display request, a screen output resolution format of the application end, along with continuous initial left frame images and initial right frame images.
an image splicer 33 configured to splice the initial left frame images and the initial right frame images according to the screen output resolution format to obtain an image to be displayed.
a frame cutter 34 configured to send the image to be displayed to the application end for data reading and cutting operation, to obtain a left frame image and a right frame image.
a frame display sender 35 configured to send the left frame image and the right frame image to a display end for image display.

In some embodiments, the apparatus further includes a first inserter configured to respectively insert, at the head and tail ends of the initial left frame image and the initial right frame image within the image to be displayed, a first start identifier for instructing the application end to perform an image start scanning operation, and a first end identifier for instructing the application end to perform an image end scanning operation.

In some embodiments, when the screen output resolution format is a first format, the image splicer 33 is configured to respectively perform image format conversion operations on the initial left frame images and the initial right frame images, so that the row data of the initial left frame images and the initial right frame images is extended and the column data is reduced; and to vertically splice the initial left frame images and the initial right frame images after the image format conversion operation to obtain the image to be displayed.

In some embodiments, when the screen output resolution format is a second format, the image splicing module 33 is configured to vertically splice the initial left frame image and the initial right frame image to obtain the image to be displayed.

In some embodiments, the apparatus further includes a second inserter configured to respectively insert, at the head and tail ends of each row of data in the initial left frame images and the initial right frame images, a second start identifier for instructing the application end to perform a row data start scanning operation, and a second end identifier for instructing the application end to perform a row data end scanning operation.

In specific implementations, the above modules may be implemented as independent entities, or they may be combined in any manner and implemented as one or more entities.

As described above, the 3D image display apparatus 30 provided in the embodiments of the present application includes: a request receiver 31 configured to receive a 3D image display request sent from an application end; a data acquisitor 32 configured to acquire, according to the 3D image display request, a screen output resolution format of the application end, along with continuous initial left frame images and initial right frame images; an image splicer 33 configured to splice the initial left frame images and the initial right frame images according to the screen output resolution format to obtain an image to be displayed; a frame cutter 34 configured to send the image to be displayed to the application end for data reading and cutting operation, so as to obtain a left frame image and a right frame image; a frame display sender 35 configured to send the left frame image and the right frame image to a display end for image display.

The embodiments of the present application also provide a 3D image display apparatus, which can be integrated into a terminal device.

Refer to FIG. 3, which is a schematic structural diagram of a 3D image display apparatus provided in the embodiments of the present application. The 3D image display apparatus 30 may include:
an image receiver 36 configured to receive an image to be displayed sent from a main board end.
an image cutter 37 configured to perform data reading and cutting operation on the image to be displayed, so as to obtain a left frame image and a right frame image.
a second display sender 38 configured to send the left frame image and the right frame image to a display end for image display.

In some embodiments, the image cutter 37 is configured to, when a first start identifier is detected in the image to be displayed, perform an image start scanning operation on the image to be displayed; treat the data between the second start identifier and the second end identifier in the image to be displayed as one row of data for data reading and cutting operation, and continue such operations until a first end identifier is detected in the image to be displayed, at which point perform an image end scanning operation to obtain the left frame image. When another first start identifier is detected in the image to be displayed, the module continues to perform the image start scanning operation; it treats the data between the second start identifier and the second end identifier in the image to be displayed as one row of data for data reading and cutting operation, and continues such operations until the first end identifier is detected in the image to be displayed, at which point it performs the image end scanning operation to obtain the right frame image.

In specific implementations, the above modules may be implemented as independent entities, or may be combined in any manner and implemented as one or more entities.

As described above, the 3D image display apparatus 30 provided in the embodiments of the present application includes: an image receiver 36 configured to receive an image to be displayed sent from a main board end; an image cutter 37 configured to perform data reading and cutting operation on the image to be displayed, so as to obtain a left frame image and a right frame image; a second display sender 38 configured to send the left frame image and the right frame image to a display end for image display.

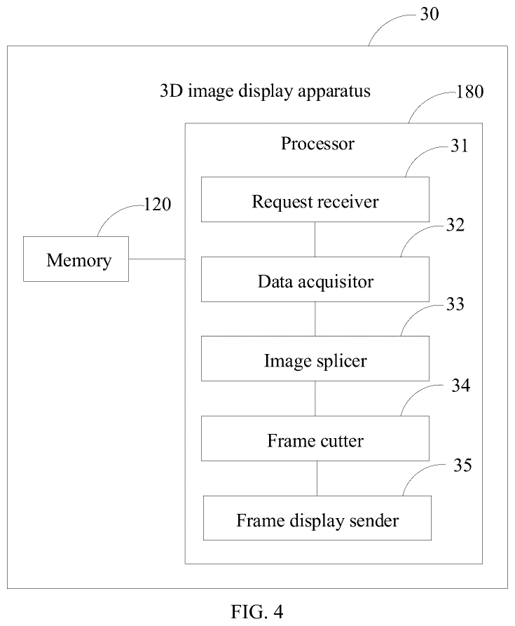

Refer to FIG. 4, which is another schematic structural diagram of a 3D image display apparatus provided in the embodiments of the present application. The 3D image display apparatus 30 includes a memory 120, one or more processors 180, and one or more applications, wherein the one or more applications are stored in the memory 120 and configured to be executed by the processor 180. The processor 180 may include a request receiver 31, a data acquisitor 32, an image splicer 33, a frame cutter 34, and a frame display sender 35. For example, the structure and connection relationships of the above components may be as follows:

The memory 120 may be used to store applications and data. The applications stored in the memory 120 include executable code. The applications can constitute various functional modules.

By running the applications stored in the memory 120, the processor 180 performs various functional operations and data processing tasks.

In addition, the memory 120 may include high-speed random access memory (RAM), and may also include non-volatile memory such as at least one disk storage device, flash memory device, or other non-volatile solid-state storage device. Accordingly, the memory 120 may also include a memory controller to provide the processor 180 with access to the memory 120.

The processor 180 serves as a control center of the apparatus. It connects various parts of the terminal through various interfaces and circuits, and by running or executing applications stored in the memory 120, as well as invoking data stored in the memory 120, it performs various functions of the apparatus and processes data, thereby providing overall control and monitoring of the apparatus. Optionally, the processor 180 may include one or more processing cores. Preferably, the processor 180 may integrate an application processor and a modem processor, wherein the application processor primarily handles the operating system, user interface, and applications.

Specifically, in this embodiment, the processor 180 may, according to the following instructions, load the executable code corresponding to the process of one or more applications into the memory 120, and execute the applications stored in the memory 120, thereby realizing various functions:

Request receiving instruction, configured to receive a 3D image display request sent from the application end.

Data acquisition instruction, configured to acquire, according to the 3D image display request, the screen output resolution format of the application end, as well as continuous initial left frame images and initial right frame images.

Image splicing instruction, configured to splice the initial left frame image and the initial right frame image according to the screen output resolution format to obtain an image to be displayed.

Frame cutting instruction, configured to send the image to be displayed to the application end for data reading and cutting operation, so as to obtain a left frame image and a right frame image.

Frame display sending instruction, configured to send the left frame image and the right frame image to the display end for image display.

In some embodiments, the program further includes a first insertion instruction, configured to respectively insert, at the head and tail ends of the initial left frame image and the initial right frame image within the image to be displayed, a first start identifier for instructing the application end to perform an image start scanning operation, and a first end identifier for instructing the application end to perform an image end scanning operation.

In some embodiments, when the screen output resolution format is the first format, the image splicing instruction is configured to respectively perform image format conversion operations on the initial left frame image and the initial right frame image, so that the row data of the initial left frame image and the initial right frame image is extended and the column data is reduced; and to vertically splice the initial left frame image and the initial right frame image after the image format conversion operation to obtain the image to be displayed.

In some embodiments, when the screen output resolution format is the second format, the image splicing instruction is configured to vertically splice the initial left frame image and the initial right frame image to obtain the image to be displayed.

In some embodiments, the program further includes a second insertion instruction, configured to respectively insert, at the head and tail ends of each row of data in the initial left frame image and the initial right frame image, a second start identifier for instructing the application end to perform a row data start scanning operation, and a second end identifier for instructing the application end to perform a row data end scanning operation.

The embodiments of the present application also provide a terminal device. The terminal device may be a server, smartphone, computer, tablet, or other similar device.

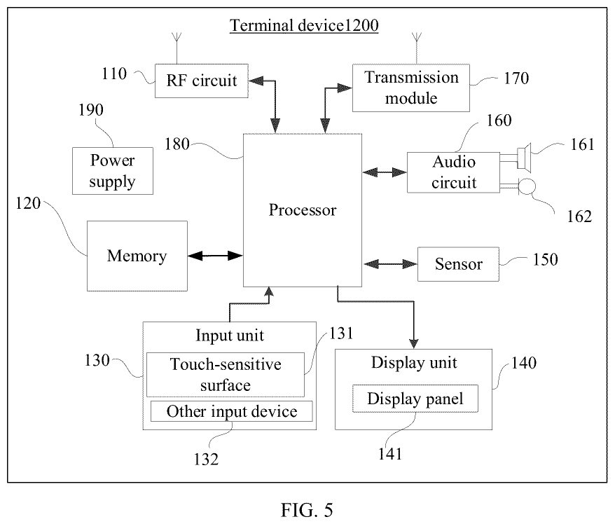

Refer to FIG. 5, which illustrates a schematic structural diagram of a terminal device provided in the embodiments of the present application. The terminal device can be used to implement the 3D image display method described in the above embodiments. The terminal device 1200 may be, for example, a television, smartphone, or tablet.

As illustrated in FIG. 5, the terminal device 1200 may include a radio frequency (RF) circuit 110, a memory 120 comprising one or more (only one is shown in the figure) computer-readable storage media, an input unit 130, a display unit 140, a sensor 150, an audio circuit 160, a transmission module 170, a processor 180 comprising one or more (only one is shown in the figure) processing cores, and a power supply 190, among other components. Those skilled in the art will understand that the structure of the terminal device 1200 shown in FIG. 5 is not intended to limit the terminal device 1200, and may include more or fewer components than those illustrated, combine certain components, or arrange components differently.

The RF circuit 110 is configured to receive and transmit electromagnetic waves and to realize the mutual conversion between electromagnetic waves and electrical signals, thereby enabling communication with a communication network or other devices. The RF circuit 110 may include various existing circuit components used to perform these functions, such as an antenna, RF transceiver, digital signal processor, encryption/decryption chip, subscriber identity module (SIM) card, memory, and so on. The RF circuit 110 may communicate with various networks such as the Internet, intranets, or wireless networks, or communicate with other devices via wireless networks.

The memory 120 may be used to store software programs and modules, such as the program instructions/modules corresponding to the 3D image display method described in the above embodiments. By running the software programs and modules stored in the memory 120, the processor 180 executes various functional applications and performs data processing. It can automatically select a vibration alert mode for 3D image display according to the current scenario in which the terminal device is located, ensuring that scenes such as meetings are not disturbed while still allowing the user to perceive incoming calls, thereby enhancing the intelligence of the terminal device. The memory 120 may include high-speed random access memory, and may also include non-volatile memory such as one or more magnetic storage devices, flash memory, or other non-volatile solid-state memory. In some examples, the memory 120 may further include remote memory configured relative to the processor 180; these remote memories may be connected to the terminal device 1200 via a network. Examples of such networks include, but are not limited to, the Internet, intranets, local area networks, mobile communication networks, and combinations thereof.

The input unit 130 may be used to receive inputted numeric or character information, as well as to generate input signals related to user settings and function control via devices such as a keyboard, mouse, joystick, optical device, or trackball. Specifically, the input unit 130 may include a touch-sensitive surface 131 and other input device 132. The touch-sensitive surface 131, also referred to as a touchscreen or touchpad, can collect user touch operations performed on or near it (for example, operations using a finger, stylus, or any suitable object or accessory on or near the touch-sensitive surface 131) and, according to a preset program, drive corresponding connected devices. Optionally, the touch-sensitive surface 131 may include two parts: a touch detection device and a touch controller. The touch detection device detects the location of the user's touch and senses signals generated by the touch operation, then transmits the signals to the touch controller. The touch controller receives touch information from the touch detection device, converts it into touch point coordinates, and sends them to the processor 180. It can also receive commands from the processor 180 and execute them accordingly. In addition, the touch-sensitive surface 131 may be implemented using various technologies such as resistive, capacitive, infrared, or surface acoustic wave touch sensing. In addition to the touch-sensitive surface 131, the input unit 130 may further include other input devices 132. Specifically, the other input devices 132 may include, but are not limited to, one or more of the following: a physical keyboard, functional keys (such as volume control buttons, power buttons, etc.), trackball, mouse, joystick, and similar devices.

The display unit 140 may be used to display information input by the user or information provided to the user, as well as various graphical user interfaces of the terminal device 1200. These graphical user interfaces may be composed of graphics, text, icons, videos, or any combination thereof. The display unit 140 may include a display panel 141. Optionally, the display panel 141 may be configured using technologies such as liquid crystal display (LCD) or organic light-emitting diode (OLED). Furthermore, the touch-sensitive surface 131 may cover the display panel 141. When the touch-sensitive surface 131 detects a touch operation performed on or near it, the detected signal is transmitted to the processor 180 to determine the type of touch event. The processor 180 then provides a corresponding visual output on the display panel 141 based on the type of touch event. Although in FIG. the touch-sensitive surface 131 and the display panel 141 are illustrated as two separate components for implementing input and output functions respectively, in some embodiments, the touch-sensitive surface 131 and the display panel 141 may be integrated into a single component to realize both input and output functionalities.

The terminal device 1200 may further include at least one sensor 150, such as a light sensor, motion sensor, or other types of sensors. Specifically, the light sensor may include an ambient light sensor and a proximity sensor. The ambient light sensor can adjust the brightness of the display panel 141 based on the brightness of the surrounding environment, while the proximity sensor can turn off the display panel 141 and/or backlight when the terminal device 1200 is moved close to the user's ear. As a type of motion sensor, the accelerometer can detect the magnitude of acceleration in various directions (typically along three axes). When the device is stationary, it can detect the magnitude and direction of gravity, and can be used in applications such as orientation detection (e.g., automatic screen rotation, relevant games, magnetometer calibration), vibration-based functions (e.g., pedometer, tapping), and more. As for other sensors that may be configured on the terminal device 1200, such as gyroscopes, barometers, hygrometers, thermometers, and infrared sensors, they are not further elaborated here.

The audio circuit 160, speaker 161, and microphone 162 provide an audio interface between the user and the terminal device 1200. The audio circuit 160 can convert received audio data into electrical signals and transmit them to the speaker 161, which in turn converts the signals into sound for output. Conversely, the microphone 162 converts collected sound signals into electrical signals, which are received by the audio circuit 160 and converted into audio data. The audio data can then be processed by the processor 180 and transmitted via the RF circuit 110 to, for example, another terminal, or output to the memory 120 for further processing. The audio circuit 160 may also include an earphone jack to enable communication between peripheral headphones and the terminal device 1200.

The terminal device 1200 can use a transmission module 170 (e.g., a Wi-Fi module) to help users send and receive emails, browse the web, access streaming media, and more. It provides the user with wireless broadband Internet access. Although FIG. 5 illustrates the presence of the transmission module 170, it should be understood that it is not an essential component of terminal device 1200 and may be omitted as needed without departing from the scope and essence of the invention.

The processor 180 serves as the control center of the terminal device 1200. It connects various components of the mobile phone through various interfaces and circuits. By running or executing software programs and/or modules stored in the memory 120, and by invoking data stored in the memory 120, the processor 180 performs various functions of the terminal device 1200 and processes data, thereby providing overall control of the mobile phone. Optionally, the processor 180 may include one or more processing cores. In some embodiments, the processor 180 may integrate an application processor and a modem processor, where the application processor primarily handles the operating system, user interface, and applications, while the modem processor primarily handles wireless communication. It should be understood that the above-mentioned modem processor may also be implemented separately and not integrated into the processor 180.

The terminal device 1200 further includes a power supply 190, which provides power to the various components. In some embodiments, the power supply may be logically connected to the processor 180 through a power management system, enabling the implementation of discharge management, power consumption control, and other power management functions. The power supply 190 may further include one or more DC or AC power sources, a recharging system, a power failure detection circuit, a power converter or inverter, a power status indicator, or any combination of such components.

Although not shown, the terminal device 1200 may further include a camera (such as a front-facing camera or a rear-facing camera), a Bluetooth module, and other components, which are not described in detail here. Specifically, in this embodiment, the display unit 140 of the terminal device 1200 is a touchscreen display. The terminal device 1200 also includes a memory 120 and one or more programs, wherein one or more of the programs are stored in the memory 120 and configured to be executed by one or more processors 180. One or more of the programs include instructions for performing the following operations:

Request receiving instruction configured to receive a 3D image display request sent from an application end.

Data acquisition instruction configured to acquire, according to the 3D image display request, a screen output resolution format of the application end, as well as continuous initial left frame images and initial right frame images.

Image splicing instruction configured to splice the initial left frame images and the initial right frame images according to the screen output resolution format to obtain an image to be displayed.

Frame cutting instruction configured to send the image to be displayed to the application end for data reading and cutting operation, so as to obtain a left frame image and a right frame image.

Frame display sending instruction configured to send the left frame image and the right frame image to a display end for image display.

In some embodiments, the program further includes a first insertion instruction, configured to respectively insert, at the head and tail ends of the initial left frame image and the initial right frame image within the image to be displayed, a first start identifier for instructing the application end to perform an image start scanning operation, and a first end identifier for instructing the application end to perform an image end scanning operation.

In some embodiments, when the screen output resolution format is the first format, the image splicing instruction is configured to respectively perform image format conversion operations on the initial left frame image and the initial right frame image, so that the row data of the initial left frame image and the initial right frame image is extended and the column data is reduced; and to vertically splice the initial left frame image and the initial right frame image after the image format conversion operation to obtain the image to be displayed.

In some embodiments, when the screen output resolution format is the second format, the image splicing instruction is configured to vertically splice the initial left frame image and the initial right frame image to obtain the image to be displayed.

In some embodiments, the program further includes a second insertion instruction, configured to respectively insert, at the head and tail ends of each row of data in the initial left frame image and the initial right frame image, a second start identifier for instructing the application end to perform a row data start scanning operation, and a second end identifier for instructing the application end to perform a row data end scanning operation.

The embodiments of the present application also provide a terminal device. The terminal device may be a smartphone, computer, or other similar device.

As described above, the embodiment of the present application provides a terminal device 1200, which performs the following steps:

Receiving a 3D image display request sent from an application end.

Acquiring, according to the 3D image display request, a screen output resolution format of the application end, along with continuous initial left frame images and initial right frame images.

Splicing the initial left frame images and the initial right frame images according to the screen output resolution format to obtain an image to be displayed.

Sending the image to be displayed to the application end for data reading and cutting operation, so as to obtain a left frame image and a right frame image.

Sending the left frame image and the right frame image to a display end for image display.

In another embodiment, the terminal device 1200 further performs the following steps:

Receiving an image to be displayed sent from a main board end.

Performing data reading and cutting operation on the image to be displayed to obtain a left frame image and a right frame image.

Sending the left frame image and the right frame image to a display end for image display.

The embodiments of the present application also provide a storage medium, wherein the storage medium stores a computer program which, when executed on a computer, causes the computer to perform the 3D image display method according to any of the above embodiments.

It should be noted that, with respect to the 3D image display method described in the present application, it will be understood by those of ordinary skill in the art that all or part of the processes for implementing the 3D image display method of the embodiments of the present application can be accomplished by controlling related hardware through a computer program. The computer program can be stored in a computer-readable storage medium, such as in the memory of a terminal device, and executed by at least one processor within the terminal device. During execution, the process may include the steps of the embodiments of the 3D image display method as described. The storage medium may include magnetic disks, optical disks, read-only memory (ROM), random access memory (RAM), or the like.

For the 3D image display device described in the embodiments of the present application, its functional modules may be integrated into a single processing chip, may exist independently as separate physical modules, or two or more modules may be integrated into one module. The integrated modules may be implemented in the form of hardware or as software functional modules. If the integrated modules are implemented as software functional modules and sold or used as independent products, they may also be stored in a computer-readable storage medium, such as a read-only memory, a magnetic disk, or an optical disk.

The above provides a detailed description of the 3D image display method, device, medium, and equipment proposed in the embodiments of the present application. Specific examples are used herein to illustrate the principles and implementation of the present application. The descriptions of the above embodiments are merely intended to help understand the method and its core concepts. At the same time, for those skilled in the art, modifications may be made to the specific implementations and application scopes based on the ideas of the present application. Therefore, the content of this specification should not be construed as a limitation on the present application.

1. A three-dimensional (3D) image display method, comprising:
receiving a 3D image display request sent from an application end;
acquiring, according to the 3D image display request, a screen output resolution format of the application end, and continuous initial left frame images and initial right frame images;
splicing the initial left frame images and the initial right frame images according to the screen output resolution format to obtain an image to be displayed;
sending the image to be displayed to the application end for data reading and cutting operation to obtain a left frame image and a right frame image; and
sending the left frame image and the right frame image to a display end for image display.

2. The 3D image display method according to claim 1, wherein when the screen output resolution format is a first format, the splicing of the initial left frame images and the initial right frame images to obtain the image to be displayed comprises:
respectively performing an image format conversion operation on the initial left frame images and the initial right frame images, such that a row data of the initial left frame images and the initial right frame images is extended and a column data of the initial left frame images and the initial right frame images is reduced;
performing a vertical splicing on the initial left frame images and the initial right frame images after the image format conversion operation to obtain the image to be displayed.

3. The 3D image display method according to claim 1, wherein when the screen output resolution format is a second format, the splicing of the initial left frame images and the initial right frame images to obtain the image to be displayed comprises:
performing the vertical splicing on the initial left frame images and the initial right frame images to obtain the image to be displayed.

4. The 3D image display method according to claim 2, wherein after the splicing of the initial left frame images and the initial right frame images to obtain the image to be displayed, the method further comprises:
respectively inserting, at head and tail ends of the initial left frame images and the initial right frame images within the image to be displayed, a first start identifier for instructing the application end to perform an image start scanning operation, and a first end identifier for instructing the application end to perform an image end scanning operation.

5. The 3D image display method according to claim 2, wherein after the splicing of the initial left frame images and the initial right frame images to obtain the image to be displayed, the method further comprises:
respectively inserting, at head and tail ends of each row of data in the initial left frame images and the initial right frame images, a second start identifier for instructing the application end to perform a row data start scanning operation, and a second end identifier for instructing the application end to perform a row data end scanning operation.

6. The 3D image display method according to claim 4, wherein the first start identifier is implemented using vertical back porch (VBP), and the VBP corresponds to a row data of a controllable area located above an active display area.

7. The 3D image display method according to claim 4, wherein the first end identifier is implemented using vertical front porch (VFP), and the VFP corresponds to a row data of a controllable area located below an active display area.

8. The 3D image display method according to claim 5, wherein the second start identifier is implemented using horizontal back porch (HBP).

9. The 3D image display method according to claim 5, wherein the second end identifier is implemented using horizontal front porch (HFP).

10-11. (canceled)

12. A 3D image display apparatus, comprising:
a request receiver configured to receive a 3D image display request sent from an application end;
a data acquisitor configured to acquire, according to the 3D image display request, a screen output resolution format of the application end, and continuous initial left frame images and initial right frame images;
an image splicer configured to splice the initial left frame images and the initial right frame images according to the screen output resolution format to obtain an image to be displayed;
a frame cutter configured to send the image to be displayed to the application end for data reading and cutting operation to obtain a left frame image and a right frame image;
a first display sender configured to send the left frame image and the right frame image to a display end for image display.

13. The 3D image display apparatus according to claim 12, wherein when the screen output resolution format is a first format, the image splicer is configured to respectively perform an image format conversion operation on the initial left frame images and the initial right frame images, such that a row data of the initial left frame images and the initial right frame images is extended and a column data of the initial left frame images and the initial right frame images is reduced; and to perform a vertical splicing on the initial left frame images and the initial right frame images after the image format conversion operation to obtain the image to be displayed.

14. The 3D image display apparatus according to claim 12, wherein when the screen output resolution format is a first format, the image splicer is configured to perform a vertical splicing on the initial left frame images and the initial right frame images to obtain the image to be displayed.

15. The 3D image display apparatus according to claim 13, further comprising a first inserter configured to respectively insert, at head and tail ends of the initial left frame images and the initial right frame images within the image to be displayed, a first start identifier for instructing the application end to perform an image start scanning operation, and a first end identifier for instructing the application end to perform an image end scanning operation.

16. The 3D image display apparatus according to claim 13, further comprising a second inserter configured to respectively insert, at head and tail ends of each row of data in the initial left frame images and the initial right frame images, a second start identifier for instructing the application end to perform a row data start scanning operation, and a second end identifier for instructing the application end to perform a row data end scanning operation.

17-19. (canceled)

20. A terminal device, comprising a processor and a memory, wherein the memory stores a plurality of instructions, and the processor loads the instructions to execute a 3D image display method, comprising:
receiving an image to be displayed sent from a main board end;
performing a data reading and cutting operation on the image to be displayed to obtain a left frame image and a right frame image; and
sending the left frame image and the right frame image to a display end for image display.

21. The terminal device according to claim 20, wherein performing the data reading and cutting operation on the image to be displayed to obtain the left frame image and the right frame image comprises:
when a first start identifier is detected in the image to be displayed, performing an image start scanning operation on the image to be displayed;
treating data between a second start identifier and a second end identifier in the image to be displayed as one row of data for data reading and cutting operation, and continuing the data reading and cutting operation until a first end identifier is detected in the image to be displayed, at which point performing an image end scanning operation to obtain the left frame image;
when another first start identifier is detected in the image to be displayed, continuing the image start scanning operation on the image to be displayed;
treating the data between the second start identifier and the second end identifier in the image to be displayed as one row of data for data reading and cutting operation, and continuing the data reading and cutting operation until the first end identifier is detected in the image to be displayed, at which point performing the image end scanning operation to obtain the right frame image.

22. The terminal device according to claim 20, wherein executing the 3D image display method further comprises:
receiving a 3D image display request sent from an application end;
acquiring, according to the 3D image display request, a screen output resolution format of the application end, and continuous initial left frame images and initial right frame images;
splicing the initial left frame images and the initial right frame images according to the screen output resolution format to obtain the image to be displayed;
sending the image to be displayed to the application end for data reading and cutting operation to obtain the left frame image and the right frame image; and
sending the left frame image and the right frame image to a display end for image display.

23. The terminal device according to claim 20, wherein when the screen output resolution format is a first format, the splicing of the initial left frame images and the initial right frame images to obtain the image to be displayed comprises:
respectively performing an image format conversion operation on the initial left frame images and the initial right frame images, such that a row data of the initial left frame images and the initial right frame images is extended and a column data of the initial left frame images and the initial right frame images is reduced;
performing a vertical splicing on the initial left frame images and the initial right frame images after the image format conversion operation to obtain the image to be displayed.

24. The terminal device according to claim 20, wherein when the screen output resolution format is a second format, the splicing of the initial left frame images and the initial right frame images to obtain the image to be displayed comprises:
performing the vertical splicing on the initial left frame images and the initial right frame images to obtain the image to be displayed.

25. The terminal device according to claim 21, wherein after the splicing of the initial left frame images and the initial right frame images to obtain the image to be displayed, the method further comprises:
respectively inserting, at head and tail ends of the initial left frame images and the initial right frame images within the image to be displayed, a first start identifier for instructing the application end to perform an image start scanning operation, and a first end identifier for instructing the application end to perform an image end scanning operation.
